(19) United States
(12) Patent Application Publication
(10) Pub. No.: US 2013/0088599 A1
(43) Pub. Date: Apr. 11, 2013

(54) CAMERA DEVICE FOR CAPTURING IMAGES OF AN EXTERNAL REGION OF A VEHICLE

(71) Applicants: Peter Ulomek, Radevormwald (DE); Gerd Buschmann, Velbert (DE); Helko Schutz, Velbert (DE)

(72) Inventors: Peter Ulomek, Radevormwald (DE); Gerd Buschmann, Velbert (DE); Helko Schutz, Velbert (DE)

(21) Appl. No.: 13/695,723

(22) PCT Filed: Nov. 19, 2010
(86) PCT No.: PCT/EP2010/007068

§ 371 Date: Nov. 1, 2012

(30) Foreign Application Priority Data
Dec. 22, 2009 (DE) 10200900425.1

(51) Int. Cl. H04N 5/225

(52) U.S. Cl. CPC H04N 5/2252
USPC 348/148

(57) ABSTRACT

The invention relates to a camera device for capturing images of an external region (30) of a vehicle. Said device comprises a camera (10) and a chamber (11) in which the camera (10) can be accommodated at least in part and which has an opening toward the outer region (30). Furthermore, an inner chamber (31), which can comprise in particular areas of the luggage compartment and/or of the passenger compartment, is provided in the vehicle. The invention further comprises at least one housing component (20), which separates the camera space (11) at least in some regions from the inner chamber (31). According to the invention, at least one housing component (20) is provided as a sealing element (21), which consists of a fluid-tight material and which is arranged such that said element seals the camera space (11) in a fluid-tight manner with respect to the inner chamber (31). The sealing element (21) consists at least in part of a flexible, elastic material, wherein the electric cables (14) of the camera (10) and/or of the drive (16), and/or the camera (10) itself, can be guided in a fluid-tight manner through the sealing element (21) and be fixed there. When the camera (10) performs a displacing motion, the movements of the electric cables (14) or of the camera (10) itself caused thereby are absorbed by the sealing element (21), which moves accordingly.

The invention relates to a device according to the preambles of claims 1 and 4. Such a camera device is used to capture images of an external region of a vehicle, in particular to capture images of the region behind the vehicle, preferably when reversing. Such camera devices are already known. The camera has a retracted position, in which it is arranged at least partially in a chamber, the camera chamber, which is sealed off from the external region with a flap or the like, and by means of an extended position, in which it can capture images of the external region. This has the advantage that the camera is not soiled during the customary driving mode of the vehicle.

EP 1 529 688 A1 describes a camera arrangement for motor vehicles. This camera can be moved between a retracted position and an extended position. The camera is arranged in a housing which has a guide slot through which the electric leads of the camera are led. Alternatively, it is also possible to dispense with the guide slot and to embody the housing in a closed fashion. In this case, the lead of the camera is led in a nonmoveable fashion through the protective wall and is made correspondingly long and flexible in the interior of the housing. A disadvantage of this arrangement is, however, that particularly during reversing exhaust gases which emerge from the exhaust can penetrate the interior of the vehicle via the camera housing. This is problematic, in particularly when persons or animals are located in the region behind the tailgate, such as for example dogs which are located in the luggage compartment. The exhaust gases are poisonous and can then be breathed in by the corresponding persons or animals, which can lead to damage to their health. If the camera is encapsulated in the housing, a correspondingly long camera lead must be provided in the housing for the camera to be able to carry out the necessary movement. However, this increases the overall height of the housing, which is also problematic since normally little installation space is available in this region.

The object of the invention is therefore to provide a camera device for vehicles which, on the one hand, prevents gases, in particular exhaust gas, and also fluids from being able to penetrate the interior of the vehicle, and which, on the other hand, permits a compact design. This object is achieved by means of the characterizing features of claims 1 and 4 which are accorded the following particular importance.

According to the first embodiment of the invention described in claim 1, at least one housing component is provided as a sealing element which is composed of a fluid-tight material and which closes off the camera chamber in a fluid-tight fashion with respect to the interior. This sealing element is itself composed of a flexible elastic material, wherein the electric leads of the camera and/or of the drive and/or the camera are guided in a fluid-tight fashion through the sealing element and secured there. If the camera then carries out its displacement movement, the electric leads of the camera also move. However, since the sealing element is composed of a flexible elastic material, it absorbs these movements or the movements of the camera and moves along with them. Since the sealing element is composed of a fluid-tight material and is also mounted in a fluid-tight fashion, it is easily possible to close off the external region with the possibly present exhaust gases or other undesired fluids from the interior of the vehicle. It is also not necessary to provide a relatively long cable in the camera chamber since the flexible sealing element moves with the leads which are connected to the camera, or with the camera itself. It is therefore possible to provide a fluid-tight camera device which can be embodied in a small and compact fashion.

In one embodiment of the invention according to patent claim 1, the camera is for the most part arranged on the side of the sealing element facing into the interior, and penetrates a cutout in the sealing element only with its lens region. This cutout is sealed in a fluid-tight fashion with the lens region or an adjoining region. The camera is therefore mainly located in the direction of the interior and is protected not only from gas but also from fluid and soiling. The sealing element which is composed of a flexible elastic material then moves along with the camera and carries out all the movements of the camera.

According to claim 4, the camera device is embodied in such a way that energy is supplied to the camera and/or to the drive inductively and/or that the data transmission to the camera takes place by means of electromagnetic waves. The camera can be encapsulated in the camera chamber by embodying the housing component or components as a fluid-tight housing. This housing then seals the camera chamber off from the interior in a fluid-tight fashion. Connections or electric leads of the camera or of the drive then do not have to be led through the housing. It is therefore also possible to fabricate the housing from a rigid material. The housing therefore does not have to carry out any movements of the camera. Of course, it is also possible here to provide the drive outside the housing.

In the camera device according to the invention there is preferably a drive provided which moves the camera in its displacement movement. Said drive can therefore ensure that the camera is moved from the retracted position into the extended position and/or from the extended position into the retracted position. In this context, the drive can be located either on the same side of the sealing element or of the housing component as the camera or can be located on the opposite side. If the drive is provided on the same side as the camera and if both are located in the camera chamber, the drive can thus either be supplied inductively with current or else via a lead which is led through the sealing element or the housing component in a fluid-tight fashion. In this context, virtually all possibilities are conceivable. The drive can, however, also be located on the opposite side of the sealing element or of the housing component as the camera. Here, for example the camera could be mounted in the camera chamber itself, while the sealing element is located in the interior. In this case, a drive element, such as for example a shaft or the like, is then led in a fluid-tight fashion through the sealing element and/or the housing component. Whether the drive is located on the same side as the camera or on the opposite side depends on the respective application.

In addition, an outflow such as a channel, a hose or the like may be provided in the camera chamber, through which outflow moisture located in the camera chamber can be conducted into the external region. If the camera is located in its extended position, it is also possible for moisture, such as for example precipitation, sprayed water or the like, to pass into the camera chamber. If the camera is then moved into its retracted position again, the moisture may be precipitated in the lens region of the camera, which reduces the quality of the capturing of images. In order to avoid this, an outflow channel may be provided on the camera chamber. Moisture which is possibly located in the camera chamber can then be conducted into the external region via said outflow channel. Of course, it is also possible to provide a hose, a pipe or the like which produces a connection between the camera chamber and the external region and therefore provides an outflow for possible moisture located in the camera chamber.

An alternative for preventing moisture from collecting in the camera chamber is to configure a region of the housing component and/or of the sealing element in such a way that although said region seals off the camera chamber from the interior in a fluid-tight fashion, in order to prevent, for example exhaust gases being able to pass into the interior, which region is permeable for some fluids from the interior to the camera chamber. Here, for example, air or even individual components of air are suitable as fluid. This can occur, in particular, by means of a semi-permeable membrane. If the opening from the external region to the camera chamber is not closed off in a completely gas-tight fashion, a partial vacuum forms in the camera chamber during travel due to the airflow. As a result, air or another fluid is sucked into the camera chamber through the region. However, as a result of the partial vacuum which is produced at the rear of the vehicle during travel, air is continuously sucked out of the camera chamber, as a result of which fluid from the interior flows into the camera chamber again through the region. As a result, moisture located in the camera chamber is also sucked out and the camera chamber is dried in this way.

Further advantages and embodiments of the invention can be found in the dependent claims, the following description and the drawings. In the drawings, the invention is illustrated in three embodiments. In the drawings:

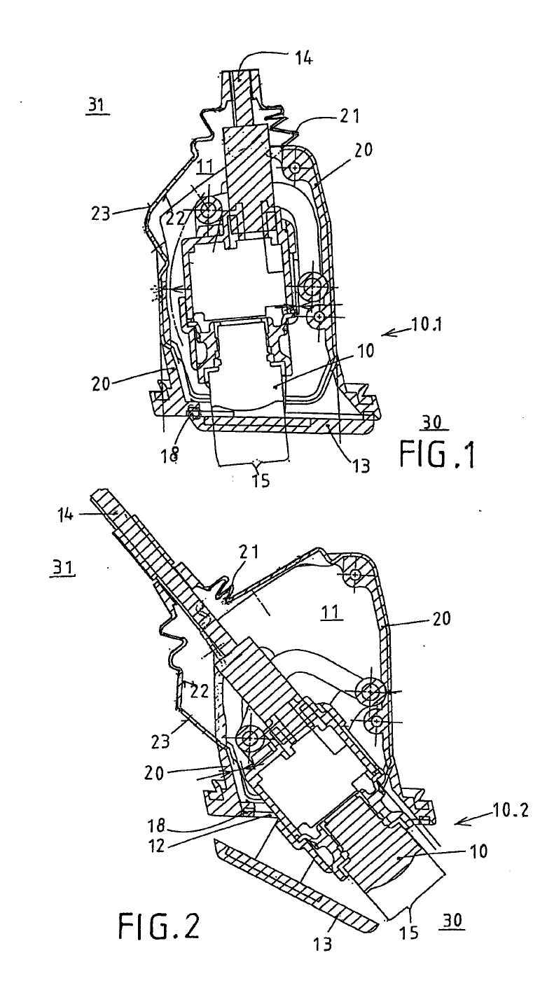

FIG. 1 shows an embodiment according to claim 1 in a retracted position in section,

FIG. 2 shows the embodiment from FIG. 1 in an extended position,

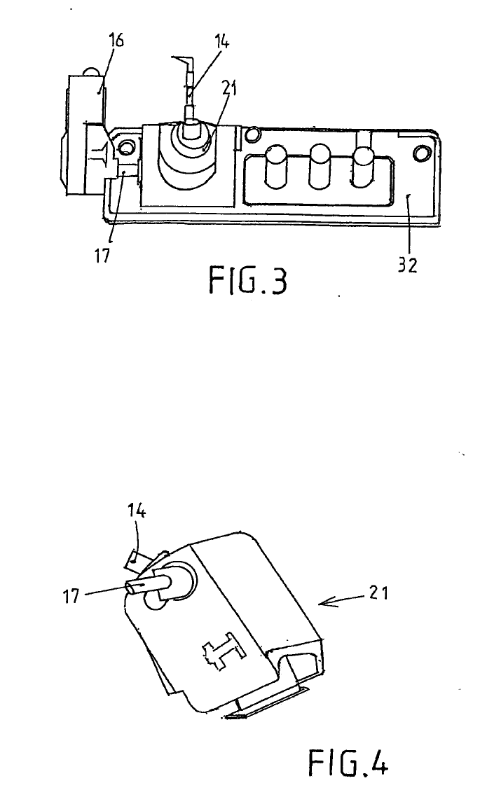

FIG. 3 shows the invention according to FIGS. 1 and 2 mounted on a handle with a drive,

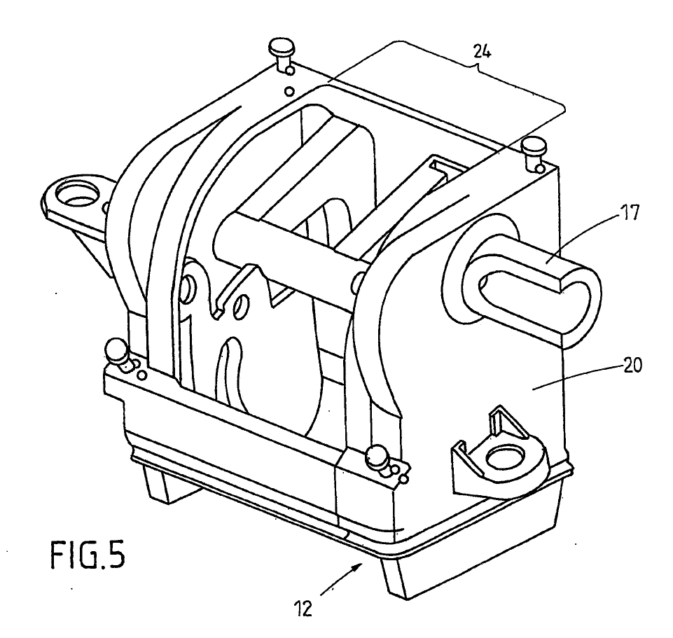

FIG. 4 shows a sealing element according to the invention according to FIGS. 1 to 3,

FIG. 5 shows a further embodiment of the invention according to claim 1, and

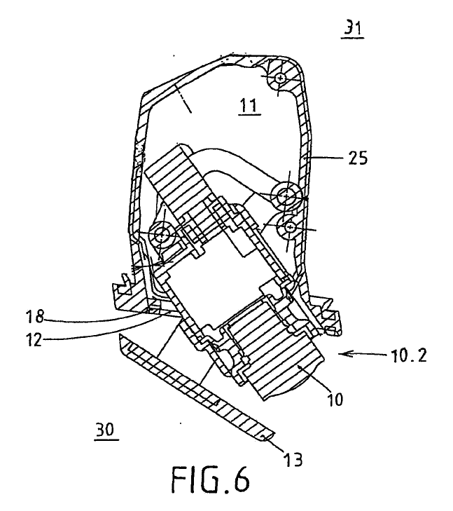

FIG. 6 shows an embodiment of the invention according to claim 4.

FIGS. 1 and 2 show an inventive embodiment of the camera device according to claim 1. In FIG. 1, the camera device is shown in the retracted position 10.1 of the camera 10. The flap 13 closes the opening 12. A sealing member 18, which seals off the camera chamber 11 in the retracted position 10.1 of the camera 10 with respect to the external region 30, is provided in the region of the opening 12. This prevents dirt and/or moisture from being able to penetrate the camera chamber 11 in the retracted position 10.1 of the camera 10.

In addition to the housing component 20, a sealing element 21 is provided. The latter is embodied here in the form of a bellows, specifically a folding bellows. Other forms of bellows are, of course, also conceivable. The bellows are composed of an elastic flexible material such as, for example, vulcanized rubber or else an injection-molded material. Of course, other materials are also conceivable. It is also possible to embody the sealing element 21 with or without the housing component as a two-component part. The sealing element can therefore have rigid regions and in addition also a flexible elastic region which ensures the necessary mobility of the sealing element.

The electric leads 14 of the camera 10 are attached to the sealing element 21 in a fluid-tight fashion. If the camera 10 is then moved from its retracted position 10.1 shown in FIG. 1 into its extended position 10.2 shown in FIG. 2, the electric leads 14 of the camera 10 move along with it and therefore also the sealing element 21. The flexibility of the sealing element 21 makes it possible to embody the entire camera device in a very compact and small fashion.

FIG. 3 then shows a specific application example of the embodiment of the invention according to FIGS. 1 and 2. The housing component 20 and the sealing element 21 are attached to a handle 32, here a handle 32 of a tailgate of a vehicle. The electric leads 14 of the camera 10 protrude out of the sealing element 21. This cannot be seen here in more detail. It is, of course, also conceivable for the camera device to be mounted at a different location instead of on a handle 32. For example the tailgate, a lighting device, the license plate, a bumper and/or a bodywork component are suitable here. Other locations on the motor vehicle are also conceivable, wherein when selecting the suitable location it is, in particular, significantly important that the camera 10 must be able to capture the desired external region of the vehicle in the extended position 10.2 of said camera 10.

Furthermore, a drive 16 is provided, which is, however, located outside the sealing element 21 and the housing components 20. Just one drive element 17, here a shaft, projects into the sealing element 21 in order to make it possible for the camera 10 to move from its retracted position 10.1 into its extended position 10.2 and back again. The location where the drive element 17 projects into the sealing element 21 is also sealed in a fluid-tight fashion.

FIG. 4 now shows a sealing element 21. This can be folded over one or more housing components 20 and is completely composed of an elastic material. The region at which the electric leads 14 of the camera 10 project out of the sealing element 21 is also configured here again in the manner of a bellows, specifically a folding bellows. On the side it is also possible to see the attachment of the drive element 17 to which the drive 16 can be connected in order to make it possible to move the camera 10 between its retracted position 10.1 and its extended position 10.2. The drive 16 is arranged here on the one side 22 of the sealing element 21 which faces the interior 31, while the camera 10 is located on the other side 23 of the sealing element 21 which faces the camera chamber 11. Of course, it is also possible to provide the drive 16 on the same side 22, 23 of the sealing element 21 as the camera 10.

FIG. 5 shows a further exemplary embodiment of the invention according to patent claim 1. Here, housing components 20 in which the camera 10 can be accommodated are provided. The drive 16 is in turn arranged outside the housing component 20, wherein a drive element 17 penetrates the housing component 20 and makes it possible to move the camera 10 between its retracted position 10.1 and its extended position 10.2. The housing component 20 has a break through 24 which can be closed off by a sealing element 21 (not shown in more detail here). Here, the sealing element 21 can be attached to the housing component 20 in a fluid-tight fashion. This sealing element 21 can also in turn be embodied as bellows in the region of the electric lead 14 of the camera 10.

Overall it is to be noted that the sealing element 21 can be located on the side of the housing component 20 facing away from the camera 10 or else on the side of the housing component 20 facing the camera 10. Said sealing element 21 can completely enclose the housing component or components 20 here, or line said housing component or components 20 on the inside. However, it is also possible to provide the sealing element 21 in such a way that it covers only breakthroughs 24 or gaps in the housing components 20. As a result of the use of the at least partially flexible sealing element 21 it is therefore possible for a fluid-tight seal to be formed between the camera chamber 11 and the interior 31.

An exemplary embodiment of the invention according to patent claim 4 is shown by FIG. 6. The camera 10 illustrated here does not have electric leads 14. Instead, it is supplied with current inductively. The images captured by the camera 10 can then be transmitted by means of electromagnetic waves to an electronics system, control unit or the like located in the vehicle. The wide variety of possibilities for transmitting data using electromagnetic waves, such as, for example, radio, Bluetooth or the like, are suitable for this.

Since it is not necessary to lead the electric leads 14 of the camera 10 through a sealing element 21, the housing components 20 can be embodied as a housing 25. This housing 25 can also be made completely of a rigid material. The camera chamber 11 is then located in the interior of the housing 25. As a result it is again possible to form a compact assembly which takes up little space. The housing components 20 or the housing 25 can also be easily configured in a fluid-tight fashion.

The drive 16 can then be provided either inside the camera chamber 11 or outside the camera chamber 11. In the latter case, a drive element 17 in turn penetrates a housing component 20 or the housing 25. If the drive 16 is located inside the camera chamber 11, the transmission of current to the drive 16 also takes place inductively. If the drive 16 is provided outside the housing components 20 or the housing 25, the transmission of current can take place in a conventional fashion.

In conclusion it is to be noted that the embodiments presented here are merely exemplary implementations of the invention. The invention is not restricted thereto. Instead, modifications and refinements are also possible.

### LIST OF REFERENCE NUMBERS

10 Camera
10.1 Retracted position
10.2 Extended position
11 Camera chamber
12 Opening
13 Flap
14 Electrical leads of 70
15 Lens region
16 Drive
17 Drive element
18 Sealing member
20 Housing component
21 Sealing element
22 One side of 21
23 Other side of 21
24 Breakthrough of 20
25 Housing
30 External region
31 Interior
32 Handle

1. A camera device for capturing images of an external region of a vehicle, said camera device comprising:
a camera; and
a chamber in which the camera is at least partially accommodated, said chamber having an opening toward the external region;
at least one housing component which can at least partially separates the camera chamber from a vehicle interior;
a drive moving the camera between an extended position and a retracted position via a displacement movement, wherein in the retracted position, the camera is located in the camera chamber and the opening is covered, and in the extended position, the camera can capture images of the external region;
electric leads via which at least one of the camera it is supplied with energy, the drive is supplied with energy, and the images captured by the camera are passed on; and
a sealing element composed of a fluid-tight material and arranged in such a way that the sealing element closes off the camera chamber in a fluid-tight fashion with respect to the interior, wherein the sealing element is at least partially composed of a flexible elastic material, and the electric leads can be guided in a fluid-tight fashion through the sealing element, and when the displacement movement of the camera is carried out, the resulting movements of at least one of the electric leads and the camera are absorbed by the sealing element, and the sealing element moves along with the at least one of the electric leads and the camera correspondingly.

2. The camera device as claimed in claim 1, in which the sealing element is a bellows.

3. The camera device as claimed in claim 1, in which the camera is arranged on one side of the sealing element facing the interior and said camera penetrates a cutout in the sealing element only with a lens region, wherein the cutout is sealed in a fluid-tight fashion with the lens region.

4. A camera device for capturing images of an external region of a vehicle, said device comprising;
a camera;
a chamber in which the camera is at least partially accommodated and which has an opening toward the external region;
a drive moving the camera between an extended position and a retracted position, wherein in the retracted position, the camera is located in the camera chamber and the opening is covered, and in the extended position, the camera can capture images of the external region through the opening;
a fluid-tight housing sealing off the camera chamber from a vehicle interior in a fluid-tight fashion, wherein at least one of the drive and camera does not include at least one of connections and electric leads extending through the housing, wherein energy is supplied to at least one of the camera and drive inductively.

5. The camera device as claimed in claim 1, in which the fluid tight housing is formed from at least one rigid housing component, and at least one sealing element is arranged in least one of inside, outside, and a region of at least one of a breakthrough and gap in the at least one rigid housing component to provide a fluid-tight seal between the camera chamber and the interior.

6. The camera device as claimed in claim 1, in which the drive is located on an opposite side of the at least one housing component as the camera, and a drive element of said drive extends in a fluid-tight fashion through at least one of the sealing element and the at least one housing component.

7. The camera device as claimed in claim 1, in which opening is covered by a flap, and at least one of the flap and the opening have a sealing member sealing the camera chamber with respect to the external region in the retracted position of the camera.

8. The camera device as claimed in claim 1, including an outflow through which outflow moisture in the camera chamber is conducted into the external region.

9. The camera device as claimed in claim 1, in which at least one of the at least one housing component and the sealing element includes a semi-permeable membrane.

10. The camera device as claimed in claim 1, in which the device is arranged on at least one of a handle, a tailgate, a lighting device, a license plate, a bumper and a bodywork component of the vehicle.

11. The camera device as claimed in claim 1, in which the drive is located on the same side of at least one of the sealing element and the at least one housing component as the camera.

12. The camera device as claimed in claim 4, in which the fluid tight housing is formed from at least one rigid housing component, and at least one sealing element is arranged in at least one of inside, outside, and a region of at least one of a breakthrough and gap in the at least one rigid housing component to provide a fluid-tight seal between the camera chamber and the interior.

13. The camera device as claimed in claim 4, in which the drive is located on an opposite side of the at least one housing component as the camera, and a drive element of said drive extends in a fluid-tight fashion through the at least one housing component.

14. The camera device as claimed in claim 4, in which opening is covered by a flap, and at least one of the flap and the opening have a sealing member sealing the camera chamber with respect to the external region in the retracted position of the camera.

15. The camera device as claimed in claim 4, including an outflow through which outflow moisture in the camera chamber is conducted into the external region.

16. The camera device as claimed in claim 4, in which the at least one housing component includes a semi-permeable membrane.

17. The camera device as claimed in claim 4, in which the device is arranged on at least one of a handle, a tailgate, a lighting device, a license plate, a bumper and a bodywork component of the vehicle.

18. The camera device as claimed in claim 4, wherein data transmission to the camera takes place by means of electromagnetic waves.

19. A camera device for capturing images of an external region of a vehicle, said device comprising;
a camera;
a chamber in which the camera is at least partially accommodated and which has an opening toward the external region
a drive moving the camera between an extended position and a retracted position, wherein in the retracted position, the camera is located in the camera chamber-and the opening is covered, and in the extended position, the camera can capture images of the external region through the opening;
a fluid-tight housing sealing off the camera chamber from a vehicle interior in a fluid-tight fashion, wherein at least one of the drive and camera does not include at least one of connections and electric leads extending through the housing, wherein data transmission to the camera takes place by means of electromagnetic waves.

20. The camera device as claimed in claim 19, wherein energy is supplied to at least one of the camera and drive inductively.
